(19) United States
(12) Patent Application Publication
(10) Pub. No.: US 2007/0024637 A1
(43) Pub. Date: Feb. 1, 2007

(54) Color smooth adjustment device and color smooth adjustment method

(76) Inventor: Hsin-I Lin, Yilan City (TW)

Correspondence Address: J.C. Patents, Inc., Suite 250, 4 Venture, Irvine, CA, 92618, US

(21) Appl. No.: 11/253,191

(22) Filed: Oct. 17, 2005

(30) Foreign Application Priority Data
Jul. 28, 2005 (TW) 94125546

(51) Int. Cl. G09G 5/02

(52) U.S. Cl. 345/604

(57) ABSTRACT

A color smooth adjustment device including an input color space converter, a predetermined adjustment circuit, a smoother and a color adjustment circuit is provide. In which, the input color space converter receives an image set signal, converts the image set signal into an HSI signal and outputs the HSI signal. The predetermined adjustment circuit receives the HSI signal a fine-tune signal, selects a corresponding adjustment signal from a built-in look-up table according to the HSI signal and the fine-tune signal, and outputs the adjustment signal. The smoother receives the image set signal and the adjustment signal, and outputs a smooth signal after a smoothing calculation. The color adjustment circuit receives the HSI signal and the smooth signal, performs a color adjustment on the HSI signal according to the smooth signal, and outputs an adjusted HSI signal.

### CROSS-REFERENCE TO RELATED APPLICATION

This application claims the priority benefit of Taiwan application serial no. 94125546, filed on Jul. 28, 2005. All disclosure of the Taiwan application is incorporated herein by reference.

### BACKGROUND OF THE INVENTION

1. Field of the Invention

The present invention relates to color smooth adjustment, and more particularly, to a color smooth adjustment device and a color smooth adjustment method for providing smooth colors on the neighboring pixels.

2. Description of the Related Art

Recently, along with the improvement of the image technology, viewers' expectation for image has shifted from basic to more complex image with presentation of colors closer to the true color of objects. The smaller the difference of color shades between pixels, the smoother the image to viewers.

FIG. 5 schematically shows a circuit block diagram of a conventional color smooth adjustment device. The color smooth adjustment device 500 includes an input color space converter 502, a color adjustment circuit 504, a predetermined adjustment circuit 506, a pre-selected region circuit 508, and an output color space converter 510, in which the color adjustment circuit 504 is electrically coupled to the input color space converter 502, the predetermined adjustment circuit 506 and the output color space converter 510. In addition, the pre-selected region circuit 508 is electrically coupled to the predetermined adjustment circuit 506.

The input color space converter 502 receives an image set signal, converts the received image set signal into an HSI signal, and provides the HSI signal to the color adjustment circuit 504. The pre-selected region circuit 508 outputs a fine-tune signal to the predetermined adjustment circuit 506 while the input color space converter 502 receives the image set signal. Then, the predetermined adjustment circuit 506 receives the fine-tune signal and the HSI signal, selects a corresponding predetermined adjustment signal from a built-in look-up table in the predetermined adjustment circuit 506 according to the fine-tune signal and the HSI signal, and outputs the adjustment signal to the color adjustment circuit 504.

Subsequently, the color adjustment circuit 504 adjusts the color of the HSI signal provided by the input color space converter 502, and outputs a adjusted HSI signal to the output color space converter 510. Finally, the output color space converter 510 converts the adjusted HSI signal into an adjusted image set signal and outputs the adjusted image set signal.

In the conventional technique, there is only a little difference in the similar colors of the HSI signal, and usually a large adjustment signal is provided by the pre-selected region circuit 508. Accordingly, the signal is magnified with little difference magnified to an undesired level. In the meantime, there is a bigger difference in the color shades on the neighboring pixels; therefore, the viewer can see a fuzzy spot on the display.

### SUMMARY OF THE INVENTION

Therefore, it is an objective of the present invention to provide a color smooth adjustment device and a color smooth adjustment method to effectively reduce the difference of the color shades between the adjusted image set signal provided by the color smooth adjustment device and the neighboring pixels and solve the problem of fuzzy spot.

The present invention provides a color smooth adjustment device. The color smooth adjustment device includes an input color space converter, a predetermined adjustment circuit, a smoother and a color adjustment circuit. In which, the input color space converter receives an image set signal, converts the image set signal into an HSI signal, and outputs the HSI signal. The predetermined adjustment circuit receives the HSI signal and the fine-tune signal, selects a corresponding adjustment signal from a built-in look-up table according to the HSI signal and the fine-tune signal, and outputs the adjustment signal. The smoother mentioned above receives the HSI signal and the adjustment signal, and outputs a smooth signal after a smoothing calculation. The color adjustment circuit receives the HSI signal and the smooth signal, performs a color adjustment on the HSI signal according to the smooth signal, and outputs the adjusted HSI signal.

In accordance with a preferred embodiment of the present invention, the smoother includes a memory device and at least one calculator. The memory device receives and stores the adjustment signal and the smooth signal. At least one calculator read(s) the adjustment signal and the smooth signal from the memory device, and output(s) a smooth signal after a smoothing calculation.

In accordance with one embodiment of the present invention, the smoothing calculation mentioned above performs the calculation on the adjustment signal according to a distance and a weighting of the current pixel and a neighborhood of the current pixel.

In accordance with one embodiment of the present invention, the neighborhood mentioned above includes a plurality of pixels.

In accordance with one embodiment of the present invention, the weighting mentioned above is an inverse ratio of the distance.

In accordance with one embodiment of the present invention, the color smooth adjustment device further includes an input color space converter, which receives and converts the adjusted HSI signal, and outputs the adjusted image set signal.

In accordance with one embodiment of the present invention, the color smooth adjustment device further includes a pre-selected region circuit, which outputs the fine-tune signal.

The present invention further provides a color smooth adjustment method. The method includes: receiving an image set signal, converting the received image set signal into an HSI signal, and outputting the HSI signal; receiving the HSI signal and a fine-tune signal, selecting a corresponding adjustment signal from a built-in look-up table according to the received HSI signal and the fine-tune signal, and outputting the adjustment signal; receiving the HSI signal and the adjustment signal, and outputting a smooth signal after a smoothing calculation; and receiving the HSI signal and the smooth signal, performing a color adjustment on the HSI signal according to the smooth signal, and outputting an adjusted HSI signal.

In accordance with one embodiment of the present invention, the color smooth adjustment method further includes receiving and converting the adjusted HSI signal, and outputting an adjusted image set signal.

In the present invention, because a smoother is added into the color smooth adjustment device, it effectively reduces the difference of the color shades between the adjusted image set signal provided by the color smooth adjustment device and the neighboring pixels and solves the problem of the fuzzy spot.

### BRIEF DESCRIPTION DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 schematically shows a circuit block diagram of a color smooth adjustment device according to a preferred embodiment of the present invention.

FIG. 2 schematically shows a circuit block diagram of a smoother according to a preferred embodiment of the present invention.

FIG. 3 schematically shows a circuit block diagram of a calculator according to a preferred embodiment of the present invention.

FIG. 4 schematically shows a flow chart illustrating a color smooth adjustment method according to a preferred embodiment of the present invention.

FIG. 5 schematically shows a circuit block diagram of a conventional color smooth adjustment device.

### DESCRIPTION PREFERRED EMBODIMENTS

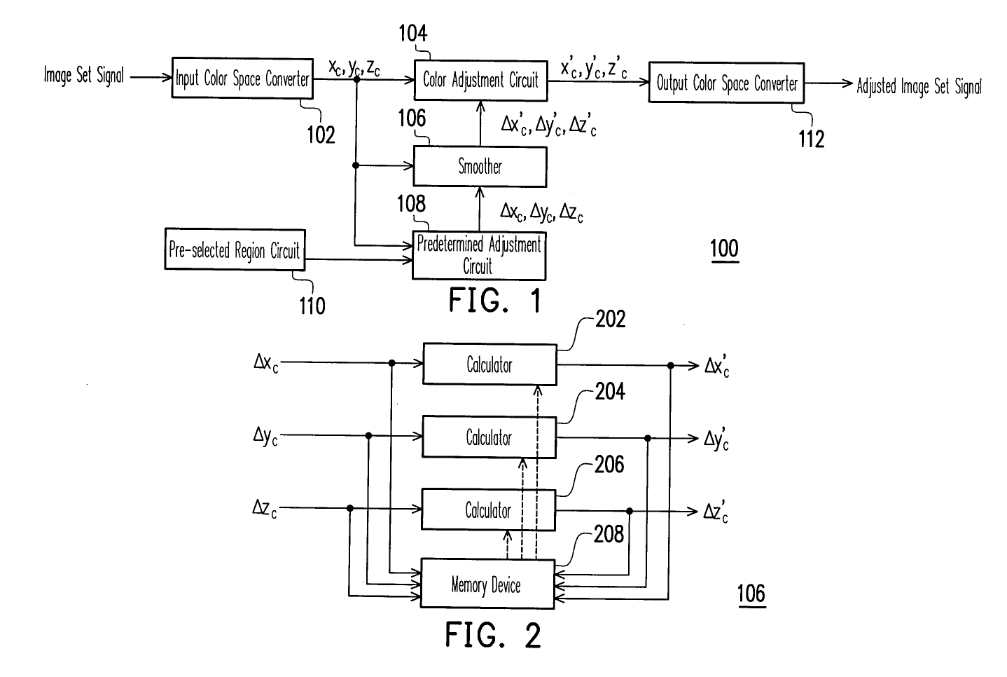

FIG. 1 schematically shows a circuit block diagram of a color smooth adjustment device according to a preferred embodiment of the present invention. In the present embodiment, the color smooth adjustment device 100 includes an input color space converter 102, a color adjustment circuit 104, a smoother 106, a predetermined adjustment circuit 108, a pre-selected region circuit 110, and an output color space converter 112.

In the present embodiment, the input color space converter 102 receives an image set signal, converts the image set signal into an HSI signal (x_{c}, y_{c}, z_{c}), and outputs the HSI signal (x_{c}, y_{c}, z_{c}), in which the subscript c represents the current pixel. In addition, the image set signal is RGB color space or other color spaces, and the HSI signal includes a hue, a saturation and an intensity of the image set signal.

A look-up table is stored in the pre-selected region circuit 110, so that an region desired to be adjusted can be selected from the xyz color space. Accordingly, a fine-tune signal provided by the pre-selected region circuit 110 is output to the predetermined adjustment circuit 108, and the fine-tune signal is represented as:
ΔS_{c}=fₛ(x_{c},y_{c},z_{c}) Equation 1

The predetermined adjustment circuit 108 electrically coupled to the input color space converter 102 receives the HSI signal and the fine tune signal, and selects a corresponding adjustment signal from the built-in look-up table according to the received HSI signal and the fine-tune signal, so as to output an adjustment signal (Δx_{c},Δy_{c},Δz_{c}) to the smoother 106.

The smoother 106 electrically coupled to the predetermined adjustment circuit 108 receives the HSI signal and the adjustment signal, and outputs a smooth signal (Δx_{c}′,Δy_{c}′,Δz_{c}′) after a smoothing calculation. FIG. 2 schematically shows a circuit block diagram of a smoother according to a preferred embodiment of the present invention. The smoother 106 includes a plurality of calculators 202-206 and a memory device 208.

Even though only three calculators 202-206 are exemplified in FIG. 2, the real case should not be limited to by such features. The calculators 202-206 perform the smoothing calculation on the received adjustment signal (Δx_{c},Δy_{c},Δz_{c}), so as to output the smooth signal (Δx_{c}′,Δy_{c}′,Δz_{c}′). Moreover, the memory device 208 stores the adjustment signal (Δx_{c},Δy_{c},Δz_{c}) and the smooth signal (Δx_{c}′,Δy_{c}′,Δz_{c}′), which are read by the calculators 202-206 later.

In the preferred embodiment of the present invention, the memory device 208 may be a random access memory (RAM), and the adjustment signal (Δx_{c},Δy_{c},Δz_{c}) and the smooth signal (Δx_{c}′,Δy_{c}′,Δz_{c}′) of the pixel adjacent to the current pixel are stored in the random access memory (RAM).

In addition, the color adjustment circuit 104 is electrically coupled to the smoother 106, the input color space converter 102, and the output color space converter 112. Moreover, the color adjustment circuit 104 receives the HSI signal and the smooth signal (Δx_{c}′,Δy_{c}′,Δz_{c}′) and adjusts the color of the HSI signal by using the smooth signal (Δx_{c}′,Δy_{c}′,Δz_{c}′), so as to output an adjusted HSI signal (x_{c}′,y_{c}′,z_{c}′).

The output color space converter 112 receives and converts the adjusted HSI signal (x_{c}′,y_{c}′,z_{c}′), so as to output an adjusted image set signal (for example, RGB color space or other color spaces).

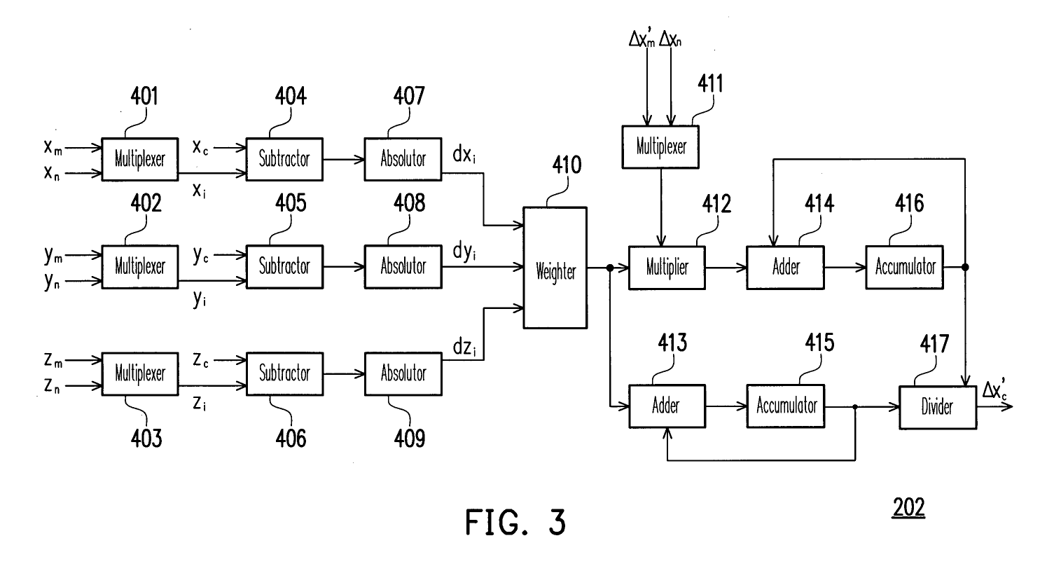

FIG. 3 schematically shows a circuit block diagram of a calculator according to a preferred embodiment of the present invention. The calculator in FIG. 3 has the same structure as that of the calculators 202-206 in FIG. 2; therefore, only one calculator 202 is exemplified herein.

The calculator 202 includes three multiplexers 401-403, three subtractors 404-406, three value absolutors 407-409, one weighter 410, one multiplexer 411, one multiplier 412, two adders 413-414, two accumulator 415-416, and one divider 417.

In the present embodiment, the calculator 202 performs the smoothing calculation according to following equation 2, and it can be represented as:

$$\begin{matrix}Δ {S}_{c}^{′} = \frac{1}{{T}_{s}} [ {\sum }_{m = 1}^{1} {W}_{s} ( m ) * Δ {S}_{m}^{′} + {\sum }_{n = {K}_{s} + 1}^{{N}_{s}} {W}_{s} ( n ) * Δ {S}_{n} ] & Equation 2 \\ {W}_{s} ( i ) = {g}_{s} ( {dx}_{i} , {dy}_{i} , {dz}_{i} ) & Equation 3 \\ {ds}_{i} = \vert {S}_{c} - {S}_{i} \vert & Equation 4 \\ {T}_{s} = {\sum }_{m = 1}^{{K}_{s}} {W}_{s} ( m ) + {\sum }_{n = Ks + 1}^{{N}_{s}} {W}_{s} ( n ) & Equation 5 \\ 1 \leq i , {K}_{s} \leq {N}_{s} , 1 \leq {N}_{s} , s ε \{ x , y , z \} & Equation 6\end{matrix}$$

In which, ΔS_{c} represents a value of the fine-tune signal for the current pixel on the HSI signal. ΔS_{c}′ represents a final adjustment value of the color adjustment after the smoothing calculation, that is a value of the adjustment signal. gₛ(dxᵢ,dyᵢ,dzᵢ) represents a weighting value. Kₛ represents the number of the neighboring pixels having been smoothed of the current pixel. Nₛ represents the number of total neighboring pixels including the current pixel. Tₛ represents a sum of the weighting values.

As shown in FIG. 3, the multiplexers 401-403 selectively output either xₘ or xₙ. In other words, xᵢ is either xₘ or xₙ. Subsequently, the subtractors 404-406 subtract the corresponding xᵢ, yᵢ and zᵢ from x_{c}, y_{c} and z_{c}, respectively, and an absolute value (dxᵢ,dyᵢ,dzᵢ) is obtained by the absolutors 407-409.

Subsequently, the weighter 410 performs an inverse operation on the obtained absolute value (dxᵢ,dyᵢ,dzᵢ) while the smoothed signal is (Δxₘ′,Δyₘ′,Δzₘ′) and the adjustment signal is (Δxₙ,Δyₙ,Δzₙ). The smoothed signal is multiplied by the adjustment signal via the multiplier 412, and accumulated by the accumulator 416 via the adder 414, so as to obtain a sum of the weighting values Tₛ as shown in equation 5, in which s represents one of three dimensions of xyz color space.

Finally, the divider 417 performs a division operation, so as to obtain a smooth signal (Δx_{c}′,Δy_{c}′,Δz_{c}′).

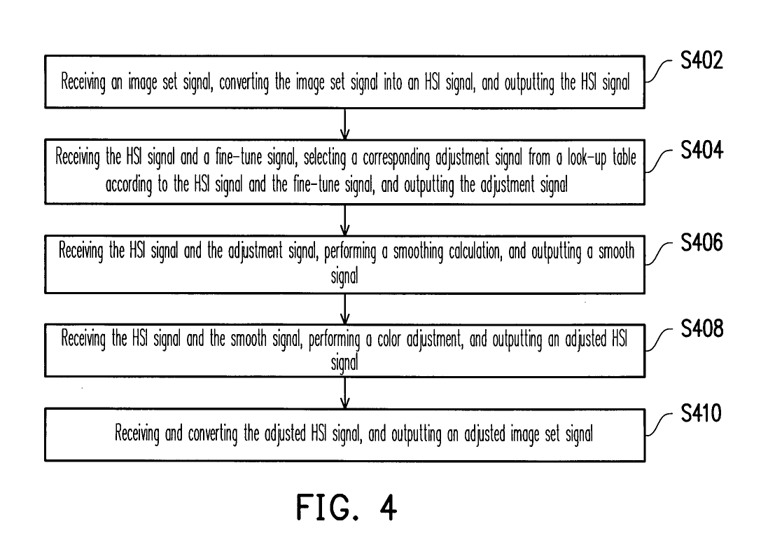

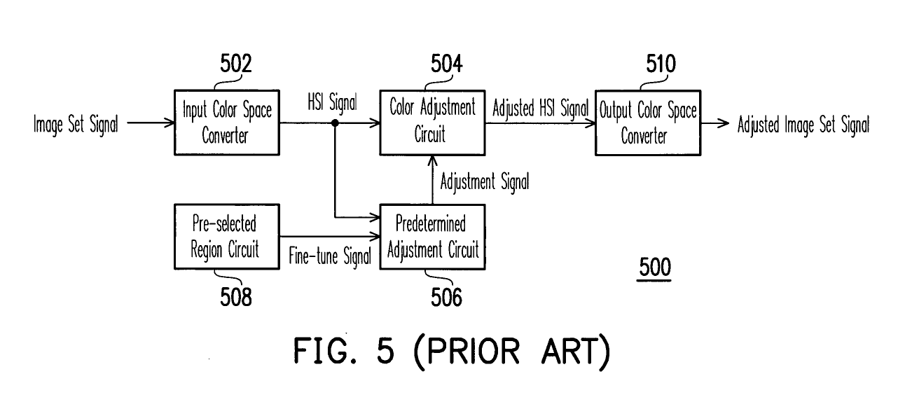

FIG. 4 schematically shows a flow chart illustrating a color smooth adjustment method according to a preferred embodiment of the present invention. In the present embodiment, the color smooth adjustment method includes following steps. First, the input color space converter 102 receives an image set signal, converts the imaged set signal into an HSI signal and outputs the HSI signal (S402). Then, the predetermined adjustment circuit 108 receives the HSI signal and a fine-tune signal, selects a corresponding adjustment signal from a built-in look-up table according to the HSI signal and the fine-tune signal, and outputs the adjustment signal (S404).

Then, the smoother 106 receives the HSI signal and the adjustment signal, and outputs the smooth signal after a smoothing calculation (S406). Finally, the color adjustment circuit 104 receives the HSI signal and the smooth signal, and outputs an adjusted HSI signal after performing a color adjustment on the HSI signal according to the smooth signal (S408).

Finally, the output color space converter 112 receives and coverts the adjusted HSI signal, and outputs an adjusted image set signal (S410).

In summary, with the color smooth adjustment device and the color smooth adjustment method provided by the present invention, the difference of the color shades between the image set signal output from the color smooth adjustment device and the neighboring pixels is significantly reduced, and the problem of fuzzy spot is effectively solved.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

What is claimed is:

1. A color smooth adjustment device, comprising:
an input color space converter for receiving an image set signal, converting the image set signal into an HSI signal, and outputting the HSI signal;
a predetermined adjustment circuit electrically coupled to the input color space converter for receiving the HSI signal and the fine-tune signal, selecting a corresponding adjustment signal from a built-in lookup table according to the HSI signal and the fine-tune signal, and outputting the adjustment signal;
a smoother electrically coupled to the predetermined adjustment circuit for receiving the HSI signal and the adjustment signal, and outputting a smooth signal after a smoothing calculation; and
a color adjustment circuit electrically coupled to the smoother and the input space converter for receiving the HSI signal and the smooth signal, performing a color adjustment on the HSI signal according to the smooth signal, and outputting an adjusted HSI signal.

2. The color smooth adjustment device of claim 1, wherein the smoother comprises:
a memory device electrically coupled to the predetermined adjustment circuit for receiving and storing the adjustment signal and the smooth signal; and
at least one calculator electrically coupled to the memory device for reading the adjustment signal and the smooth signal from the memory device, performing the smoothing calculation, and outputting the smooth signal.

3. The color smooth adjustment device of claim 1, wherein the smoothing calculation performs a calculation on the adjustment signal according to a distance and a weighting of a current pixel and a neighborhood of the current pixel.

4. The color smooth adjustment device of claim 3, wherein the neighborhood comprises a plurality of pixels.

5. The color smooth adjustment device of claim 3, wherein the weighting is an inverse ratio of the distance.

6. The color smooth adjustment device of claim 1, further comprising an output color space converter electrically coupled to the color adjustment circuit for receiving and converting the adjusted HSI signal, and outputting an adjusted image set signal.

7. The color smooth adjustment device of claim 1, further comprising a pre-selected region circuit electrically coupled to the predetermined adjustment circuit for outputting the fine-tune signal.

8. The color smooth adjustment device of claim 1, wherein the HSI signal comprises a hue, a saturation, and an intensity of the image set signal.

9. A color smooth adjustment method, comprising:
receiving an image set signal, converting the image set signal into an HSI signal, and outputting the HSI signal;
receiving the HSI signal and a fine-tune signal, selecting a corresponding adjustment signal from a built-in look-up table according to the HSI signal and the fine-tune signal, and outputting the adjustment signal;
receiving the HSI signal and the adjustment signal, performing a smoothing calculation, and outputting a smooth signal; and
receiving the HSI signal and the smooth signal, performing a color adjustment on the HSI signal according to the smooth signal, and outputting an adjusted HSI signal.

10. The color smooth adjustment method of claim 9, wherein the smoothing calculation performs a calculation on the adjustment signal according to a distance and a weighting of a current pixel and a neighborhood of the current pixel.

11. The color smooth adjustment method of claim 10, wherein the neighborhood comprises a plurality of pixels.

12. The color smooth adjustment method of claim 10, wherein the weighting is an inverse ratio of the distance.

13. The color smooth adjustment method of claim 10, further comprising receiving and converting the adjusted HSI signal, and outputting an adjusted image set signal.

14. The color smooth adjustment method of claim 9, wherein the HSI signal comprises a hue, a saturation, and an intensity of the image set signal.
